(19) United States
(12) Patent Application Publication
(10) Pub. No.: US 2026/0289153 A1
(43) Pub. Date: Sep. 24, 2026

(54) SYSTEMS AND METHODS FOR GENERATING ATTRIBUTION INFORMATION

(71) Applicant: ADOBE INC., SAN JOSE, CA (US)

(72) Inventors: Puneet Mathur, Sunnyvale, CA (US); Nedim Lipka, Campbell, CA (US); Alexa Siu, San Jose, CA (US); Verena Kaynig-Fittkau, Cambridge, MA (US); Tong Sun, San Ramon, CA (US); Rohit Ramaprasad, San Jose, CA (US); Roshan Santhosh, Redwood City, CA (US)

(21) Appl. No.: 19/087,974

(22) Filed: Mar. 24, 2025

(51) Int. Cl. G06F 40/40; G06F 16/2457; G06F 40/177; G06F 40/279

(52) U.S. Cl. CPC G06F 40/40; G06F 16/24578; G06F 40/177; G06F 40/279

(57) ABSTRACT

A method, apparatus, non-transitory computer readable medium, and system for data processing includes obtaining a data store and input text, where the data store includes data and the input text describes the data, generating a description of a structural element of the data, and generating attribution information for the input text based on the description of the structural element.

### BACKGROUND

Language models, such as large language models (LLMs), are machine learning models that are trained to output text based on an input, such as a text query. Language models store information in parametric memory that can be used to perform natural language processing tasks, such as question answering.

Existing data processing systems may also use a retrieval-augmented generation (RAG) process to answer questions by retrieving information corresponding to a question and using a language model to generate an answer to the question based on the retrieved information. It is useful to provide a citation to a portion of the retrieved information that supports the answer so that the accuracy of the answer can be verified.

### SUMMARY

Systems and methods are described for generating attribution information. In one example, a data processing apparatus uses a language generation model to generate a natural language description of a data store. The language generation model determines a similarity between a portion of an input text and a structural element of the data store based on the natural language description. The language generation model generates attribution information indicating the most similar structural element of the data store.

The natural language description of the data store enhances a contextual understanding of structural elements of the data store and reduces data misinterpretations. Therefore, generating the attribution information based on the natural language description of the data store using a language generation model is more accurate than generating the attribution information based on the raw data store and the input text using a comparative language model, and is more accurate than retrieving the attribution information based on embeddings of the raw data store and of the input text.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a data processing system according to aspects of the present disclosure.

FIG. 2 shows an example of a method for answer annotation according to aspects of the present disclosure.

FIG. 3 shows an example of a data processing system for generating attribution information according to aspects of the present disclosure.

FIG. 4 shows an example of a data processing system for formatting a data store according to aspects of the present disclosure.

FIG. 5 shows an example of a data processing system for generating a set of structural element descriptions according to aspects of the present disclosure.

FIG. 6 shows an example of a data processing system for decomposing input text according to aspects of the present disclosure.

FIG. 7 shows an example of a data processing system for sufficiency re-reranking according to aspects of the present disclosure.

FIG. 8 shows an example of a transformer according to aspects of the present disclosure.

FIG. 9 shows an example of a method for generating attribution information according to aspects of the present disclosure.

FIG. 10 shows an example of a method for generating attribution information for a data table according to aspects of the present disclosure.

FIG. 11 shows an example of a flow diagram depicting an algorithm as a step-by-step procedure for training a machine learning model according to aspects of the present disclosure.

FIG. 12 shows an example of a computing device according to aspects of the present disclosure.

FIG. 13 shows an example of a data processing apparatus according to aspects of the present disclosure.

### DETAILED DESCRIPTION

### Overview

Language models (e.g., machine learning models trained to generate text based on an input) are capable of generating answers to queries based on retrieved contextual information, but are prone to hallucination, or generating plausible-sounding yet non-factual information, which undermines user trust. An absence of a citation to supporting evidence for a generated answer complicates verification of language model-generated outputs.

A language model may generate an answer to a query based on a data store, or a set of structured or semi-structured data. Data stores are widely used for handling complex data in various domains, including healthcare, finance, and education. A data store presents unique processing challenges to a language model, such as hierarchical header structures, varying data formats (e.g., JSON, HTML, CSV, markdown, etc.), a lack of straightforward serialization techniques, noisy content, and ambiguity in raw data (e.g., abbreviations, domain-specific terms, etc.). In particular, language models are not well-trained to process tabular data at a fine-grained, structural element level (such as rows and columns) due to a lack of training data. Therefore, existing language models are not able to generate accurate citations to particular structural elements of data stores.

Accordingly, systems and methods are described for generating attribution information. In one example, a data processing apparatus uses a language generation model to generate a natural language description of a data store. The language generation model determines a similarity between a portion of an input text and a structural element of the data store based on the natural language description. The language generation model generates attribution information indicating the most similar structural element of the data store based on the determination.

The natural language description of the data store enhances a contextual understanding of structural elements of the data store and reduces data misinterpretations. Therefore, generating the attribution information based on the natural language description of the data store using a language generation model is more accurate than generating the attribution information based on the raw data store and the input text using a comparative language model. Furthermore, the attribution information generated by the data processing system is more accurate than comparative attribution information retrieved based on embeddings of the raw data store and of the input text.

### Terminology Examples

A “data store” refers to both content and structure of a set of data, where the content includes the data and the structure can include a “structural element” such as a row, a column, a cell, or a sheet (as in a table structure), structured attributes, nodes and edges of a structural graph, etc. A “description” of a structural element is text that describes the structural element in natural language.

A “data table” refers to data organized according to a tabular format (e.g., in cells defined by intersections of rows and columns). A row or a column of a data table may include a header, or a cell that does not intersect with another row or column. In some embodiments, a data table is an HTML table having an HTML tabular format. In some embodiments, a data table is an XML table having an XML tabular format. In some embodiments, a data table is an HTML table or an XML table. In some embodiments, a data store may be converted into a data table having a tabular format by converting a structural element of the data store into a corresponding structural element of the data table.

Data in a database may be organized as a data store. A data store may be included as a table in a document. A “document” is a piece of written, printed, or electronic matter that includes information. Examples of a document include a word processing document file, a text document file, a Portable Document Format (PDF) file, a web page, a spreadsheet file, a presentation slide file, a smartphone or tablet app, etc.

“Input text” refers to an input to a language generation model comprising a text string. In some embodiments, the input text is text that was generated by the language generation model based on a data store. The language generation model then processes the input text to generate attribution information from the data store for the input text.

A “language generation model” is a machine learning model trained to generate text based on an input (e.g., a language model). In some embodiments, the language generation model includes one or more transformers. In some embodiments, the language generation model includes a decoder-only model. In some embodiments, the language generation model includes a model trained to generate an embedding of a sentence. In some embodiments, the language generation model is trained to call a function or library (for example, internally, or externally, such as via an application programming interface (API)) to perform a task, such as generating an embedding of a sentence or calculating a cosine similarity between two embeddings.

An “embedding” is a representation of an object in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar and thus “closer” to each other, thereby allowing a similarity between different objects corresponding to different embeddings to be readily determined.

An “embedding space” (or a “vector space”) refers to a mathematical set having embeddings (or vectors) as components, and is characterized by a dimension specifying a number of independent directions in the embedding space.

The language generation model may generate an output based on a prompt. A “prompt” is an input to the language generation model that includes text instructing the language generation model to generate a particular output.

“Attribution information” refers to information that identifies one or more structural elements of a data store or a data table as a source for one or more portions of input text. In some embodiments, attribution information includes text identifying the structural element. In some embodiments, attribution information includes a visual representation (e.g., a highlighted portion of a visual representation of the data store or the data table). In some embodiments, attribution information includes a combination of text and a visual representation.

An example of the present disclosure is used in a question answering context. In the example, the user provides a query relating to a data store, and the language generation model generates an answer to the query based on the data store. The language generation model generates a natural language description of the data store and determines a portion of the data store to be the source for the answer based on the description. The language generation model generates attribution information indicating the portion of the data store based on the determination. The language generation model generates an annotated answer including the answer and the attribution information and provides the annotated answer to the user.

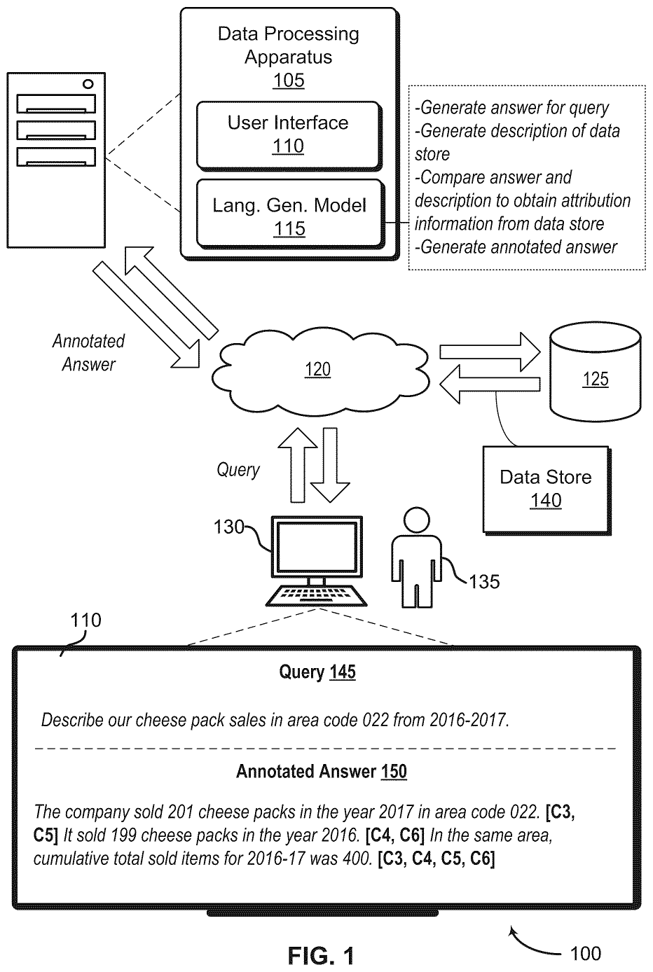

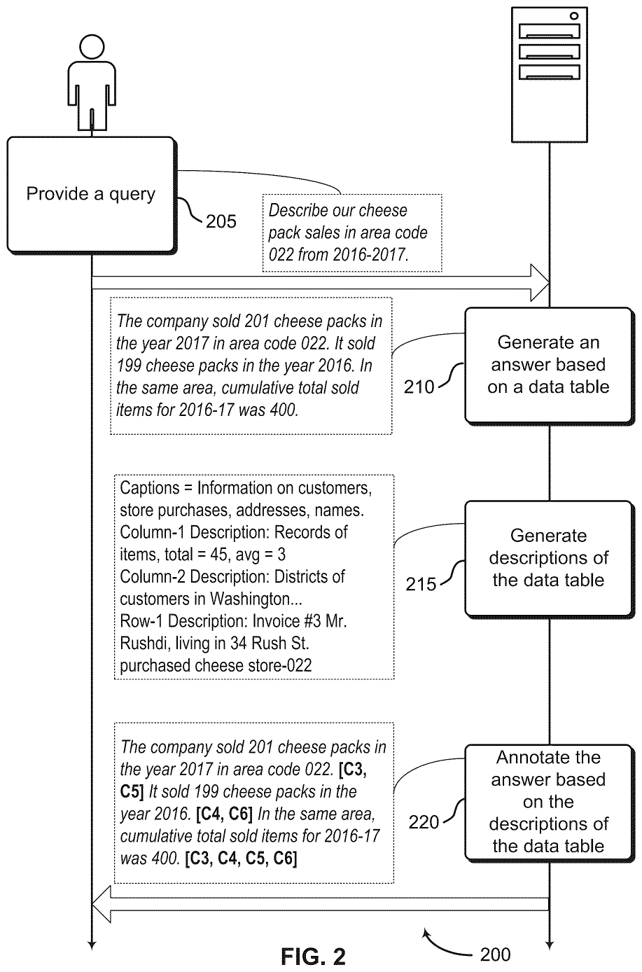

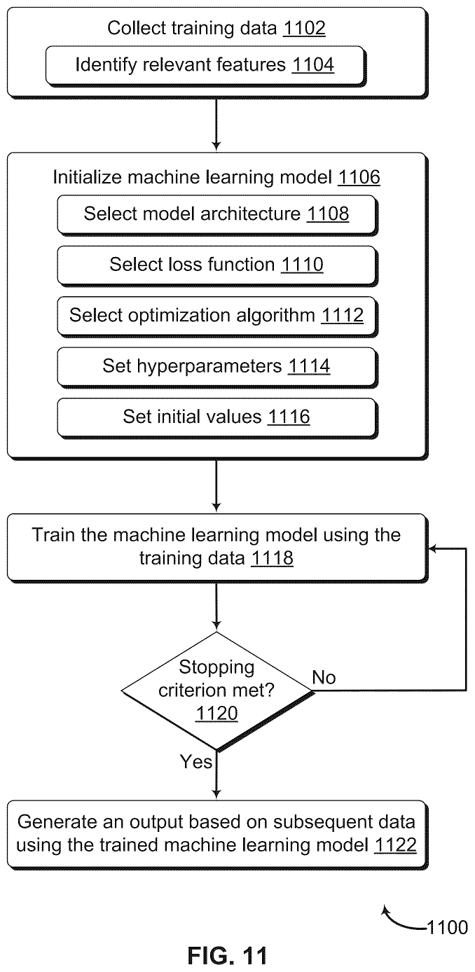

Further examples of the present disclosure in a question answering context are provided with reference to FIGS. 1-2. Details regarding the architecture of the data processing system are provided with reference to FIGS. 1, 3-8, and 12-13. Examples of a process for generating attribution information are provided with reference to FIGS. 2 and 9-10. Examples of a process for training a machine learning model are provided with reference to FIG. 11.

### Data Processing System

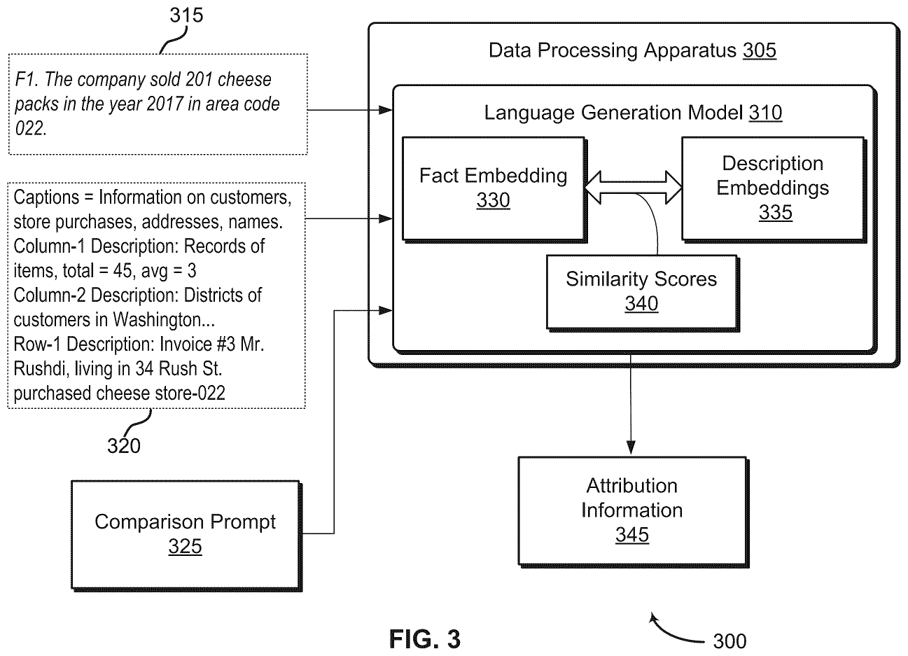

FIG. 1 shows an example of a data processing system 100 according to aspects of the present disclosure. The example shown includes data processing system 100, query 145, and annotated answer 150. Data processing system 100 is an example of, or includes aspects of, the corresponding element described with reference to FIGS. 3-8. In one aspect, data processing system 100 includes data processing apparatus 105, cloud 120, and database 125.

In one aspect, data processing apparatus 105 includes user interface 110 and language generation model 115.

Referring to FIG. 1, a user (e.g., user 135) uses data processing system 100 to generate an annotated answer to a query (e.g., query 145). In an example, a user provides a query (e.g., query 145, “Describe our cheese pack sales in area code 022 from 2016-2017.”) to data processing apparatus 105 via user interface 110 displayed on a user device (e.g., user device 130) by data processing apparatus 105. Data processing apparatus 105 retrieves a data store (e.g., data store 140, a data table) from database 125 based on the query and generates an answer (“The company sold 201 cheese packs in the year 2017 in area code 022. It sold 199 cheese packs in the year 2016. In the same area, cumulative total sold items for 2016-17 was 400.”) based on the query and the data store. In some embodiments, the user provides the data store to data processing system 100. The answer is an example of “input text” as described herein.

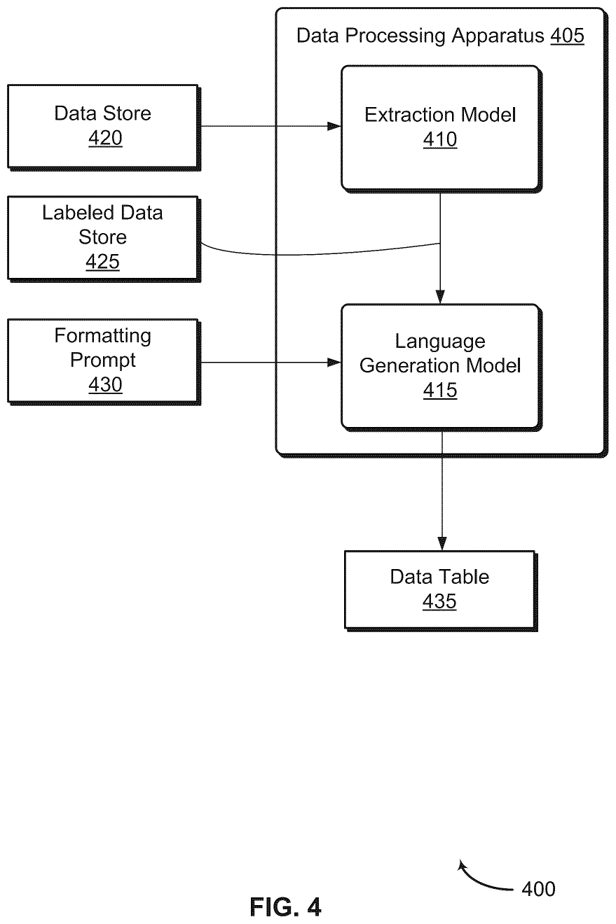

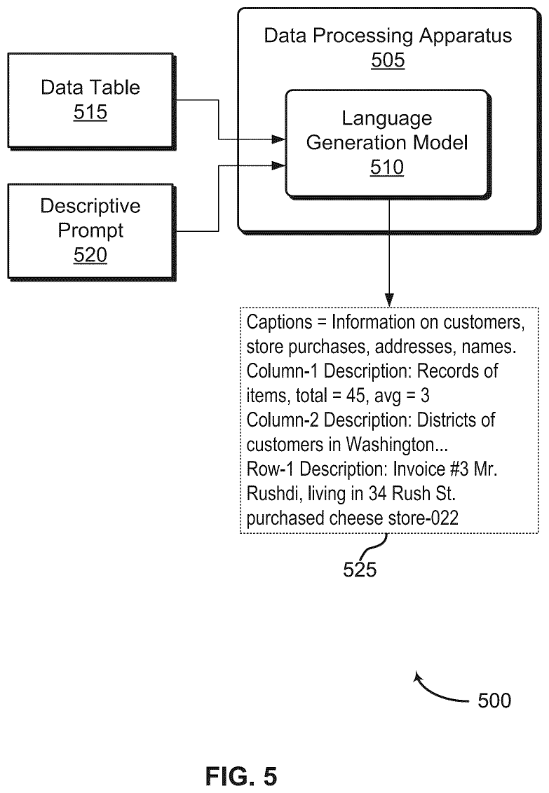

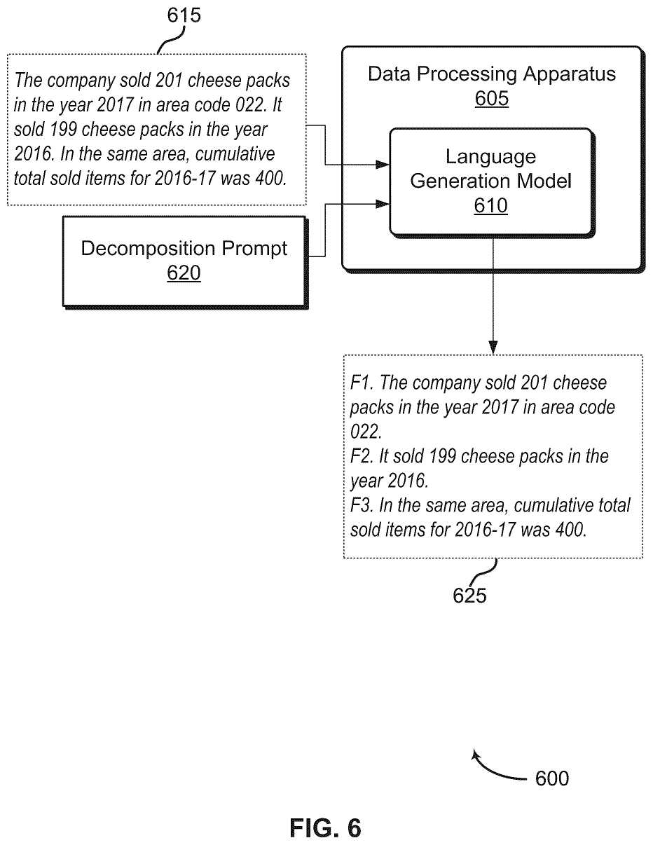

To generate an annotated answer (e.g., annotated answer 150) including attribution information identifying structural elements of the data store that support the answer, language generation model 115 generates a natural language description of each structural element of the data store as described with reference to FIGS. 4-5, decomposes the answer into a set of discrete facts as described with reference to FIG. 6, determines a similarity between each fact and each structural element, and identifies a structural element that is most similar to a fact as attribution information for the fact as described with reference to FIG. 3. Language generation model 115 can make a more accurate comparison of the natural language description of the data store and the set of facts than of the data store itself and the set of facts. Language generation model 115 generates the annotated answer by inserting the attribution information (e.g., [C3, C5], indicating columns 3 and 5 of data store 140) into the answer where appropriate. User interface 110 displays the annotated answer to the user.

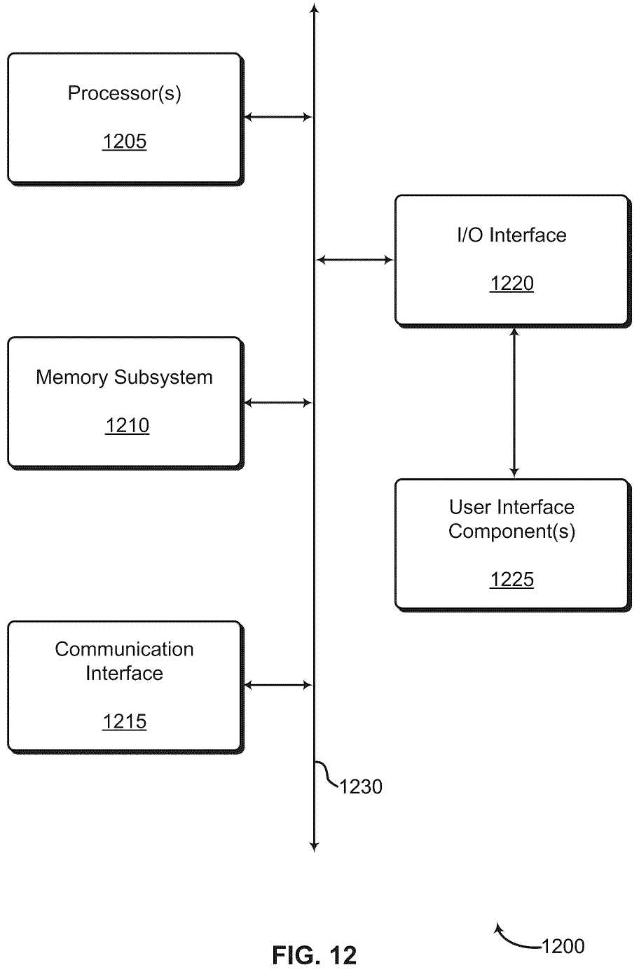

Data processing apparatus 105 is an example of, or includes aspects of, the corresponding element described with reference to FIGS. 3-7 and 12-13. According to some aspects, data processing apparatus 105 includes a computer-implemented network. In some embodiments, the computer-implemented network includes language generation model 115. Data processing apparatus 105 may also include one or more processors, a memory subsystem, a communication interface, an I/O interface, one or more user interface components, and a bus as described with reference to FIG. 12. Additionally, data processing apparatus 105 may communicate with the user device and database 125 via cloud 120.

According to some aspects, data processing apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

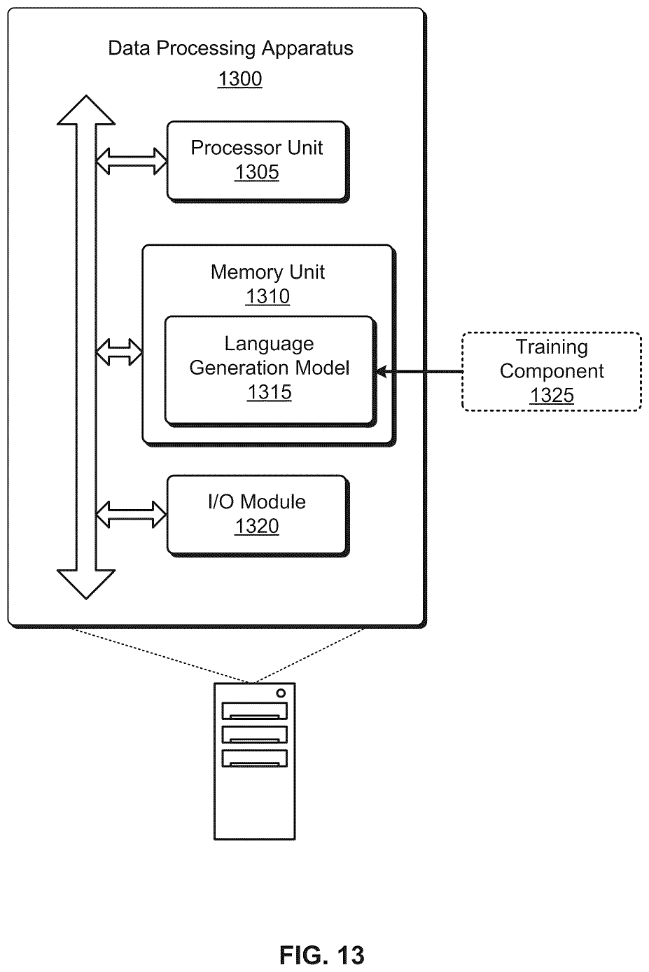

User interface 110 allows information to be communicated between the user and data processing apparatus 105. According to some aspects, user interface 110 comprises a text interface, a graphical user interface, or a combination thereof. According to some aspects, user interface 110 comprises software stored in a memory unit of data processing apparatus 105 (such as the memory unit 1310 described with reference to FIG. 13).

Language generation model 115 is an example of, or includes aspects of, the corresponding element described with reference to FIGS. 3-7 and 13. According to some aspects, language generation model 115 comprises machine learning parameters stored in the memory unit of data processing apparatus 105. According to some aspects, language generation model 115 comprises an artificial neural network (ANN) that is trained as described with reference to FIG. 11 to generate a text output based on an input.

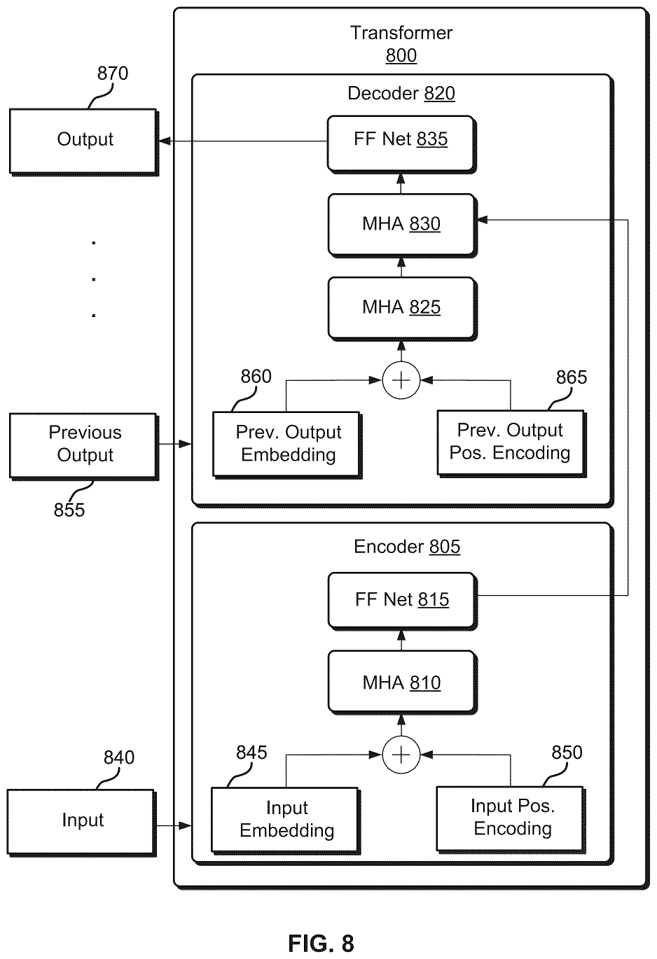

In some embodiments, language generation model 115 comprises a transformer, such as the transformer described with reference to FIG. 8. In some cases, a transformer comprises an encoder and a decoder. The encoder takes in input data, such as a sentence, and encodes the input into a set of continuous representations or embeddings. The encoder processes the entire input sequence at once, learning relationships between each of the tokens in the sequence. The decoder takes the encoded information as input and generates an output sequence one token at a time. The decoder attends to previous tokens that the decoder has generated, allowing the decoder to make predictions about a next token in a sequence.

According to some aspects, language generation model 115 comprises a decoder-only language model. A decoder-only language model, such as a generative pretrained transformer, omits an encoder and performs autoregressive text generation by predicting one output token at a time based on an input sequence of text, where each prediction is conditioned on tokens that the model has already generated. After generating the first token, the decoder-only language model adds the first token to the input and predicts a next token, continuing the process. The decoder uses self-attention to attend to previously generated tokens, helping the decoder-only language model to understand relationships between each of the tokens in the sequence, allowing the decoder-only language model to generate coherent and contextually appropriate text.

According to some aspects, language generation model 115 comprises a sentence embedding model that is trained to generate an embedding of an input sentence, such as LLM2Vec.

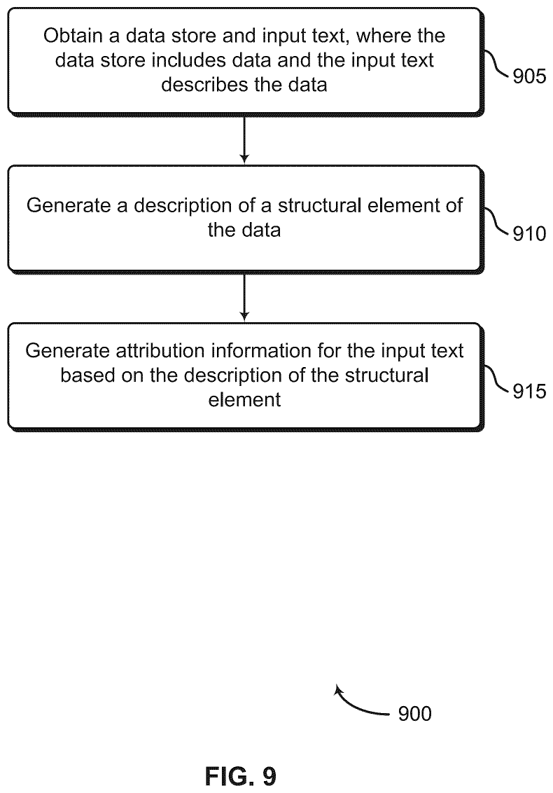

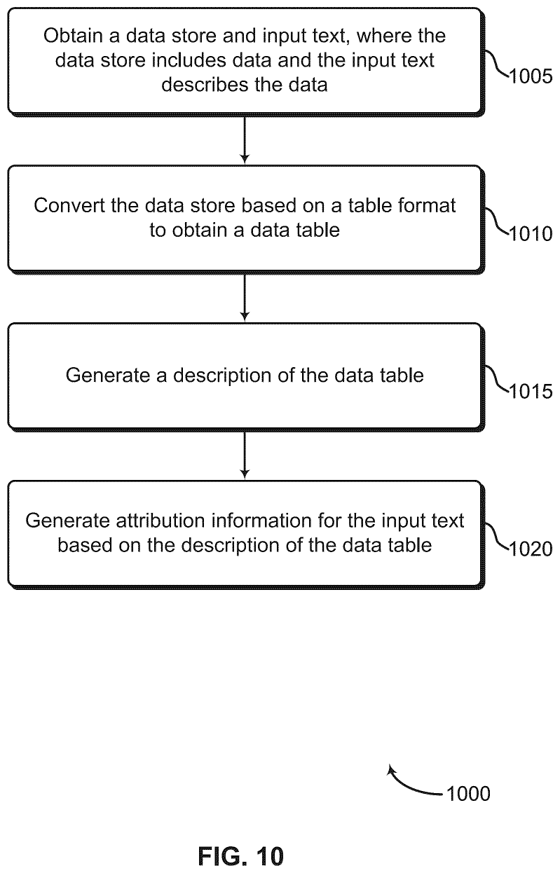

Further detail regarding the architecture of a data processing system is provided with reference to FIGS. 3-8 and 12-13. Further detail regarding a processes for generating attribution information is provided with reference to FIGS. 9-10. Further detail regarding a process for training language generation model 115 is provided with reference to FIG. 11.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. In some examples, cloud 120 is limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between data processing apparatus 105, database 125, and the user device.

Database 125 is an organized collection of data. In an example, database 125 stores data in a specified format known as a schema. According to some aspects, database 125 is structured as a single database, a distributed database, multiple distributed databases, or an emergency backup database. Data storage and processing in database 125 is manageable by a database controller, which can be operated by a user or automatically without interaction from the user. According to some aspects, database 125 is included in data processing apparatus 105. According to some aspects, database 125 is external to data processing apparatus 105 and communicates with data processing apparatus 105 via cloud 120. In some embodiments, database 125 stores data store 140. Data store 140 is an example of, or includes aspects of, the corresponding element described with reference to FIGS. 3-4.

According to some aspects, user device 130 is a personal computer, laptop computer, mainframe computer, palmtop computer, personal assistant, mobile device, or any other suitable processing apparatus. In some examples, user device 130 includes software that displays user interface 110 provided by data processing apparatus 105.

According to some aspects, a user device user interface enables a user to interact with user device 130. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

FIG. 2 shows an example of a method 200 for answer attribution according to aspects of the present disclosure. Referring to FIG. 2, a data processing system (such as the data processing system 100 described with reference to FIG. 1) performs method 200 to generate an annotated answer to a query. In an example, a user provides a query (“Describe our cheese pack sales in area code 022 from 2016-2017.”) to the data processing system. The data processing system retrieves a data table (e.g., a data store) based on the query and generates an answer (“The company sold 201 cheese packs in the year 2017 in area code 022. It sold 199 cheese packs in the year 2016. In the same area, cumulative total sold items for 2016-17 was 400.”) based on the query and the data table. The answer is an example of “input text” as described herein.

To generate an annotated answer including attribution information identifying structural elements of the data table that support the answer, the data processing system uses a language generation model to generate a natural language description of each structural element of the data table (“Captions=Information on customers, store purchases, addresses, names. Column-1 Description: Records of items, total=45, avg=3 Column-2 Description: Districts of customers in Washington. . . . Row-1 Description: Invoice #3 Mr. Rushdi, living in 34 Rush St . . . ” [remaining descriptions omitted]), determines a similarity between portions of the answer and each structural element, and identifies a structural element that is most similar to a portion of the answer as attribution information for the portion. The language generation model generates the annotated answer by inserting the attribution information (e.g., [C3, C5], indicating columns 3 and 5 of the data table) into the answer where appropriate.

At operation 205, a user provides a query. In some cases, the operations of this step may be performed by a user as described with reference to FIG. 1. In an example, the user provides the query to a data processing apparatus of the data processing system via a user interface as described with reference to FIG. 1.

At operation 210, the system generates an answer based on a data table. In some cases, the operations of this step refer to, or may be performed by, a data processing apparatus as described with reference to FIGS. 1, 3-7, and 12-13. In an example, the data processing apparatus retrieves the data table from a database based on the query and uses the language generation model to generate the answer to the query based on the data table.

At operation 215, the system generates descriptions of the data table. In some cases, the operations of this step refer to, or may be performed by, a data processing apparatus as described with reference to FIGS. 1, 3-7, and 12-13. In an example, the data processing apparatus uses language generation model to generate descriptions of structural elements of the data table (e.g., columns and rows) as described with reference to FIG. 5.

At operation 220, the system annotates the answer based on the descriptions of the data table. In some cases, the operations of this step refer to, or may be performed by, a data processing apparatus as described with reference to FIGS. 1, 3-7, and 12-13. In an example, the data processing apparatus uses the language generation model to generate attribution information for the answer based on the descriptions of the data table as described with reference to FIG. 3. In an example, the language generation model inserts the attribution information into the answer to obtain the annotated answer. The data processing apparatus displays the annotated answer to the user.

FIG. 3 shows an example of a data processing system 300 for generating attribution information according to aspects of the present disclosure. The example shown includes data processing system 300, fact 315, set of structural element descriptions 320, comparison prompt 325, fact embedding 330, description embeddings 335, similarity scores 340, and attribution information 345. In one aspect, data processing system 300 includes data processing apparatus 305. In one aspect, data processing apparatus 305 includes language generation model 310.

Referring to FIG. 3, data processing system 300 compares a natural language description of a data store (e.g., the set of structural element descriptions 320, generated as described with reference to FIGS. 4-5) to a fact from an input text (e.g., fact 315, generated as described with reference to FIG. 6) to obtain attribution information from the data store for the fact (e.g., attribution information 345).

The raw content of a table (e.g., the data store) may include ambiguous information (e.g., abbreviations, domain-specific terms, signs, numbers with or without units, ill-defined row/column headers) that would benefit from further clarification and may not have sufficient context for machine learning factual attribution. Therefore, data processing system 300 leverages descriptions of structural elements of the data store (generated as described with reference to FIG. 5) rather than the raw structural elements themselves to encourage the fact and table structure information to be in-domain for language generation model 310, thereby allowing language generation model 310 to generate accurate attribution information for the fact given the set of structural element descriptions.

For example, data processing apparatus 305 provides a fact (e.g., fact 315), a set of structural element descriptions (e.g., set of structural element descriptions 320), and comparison prompt 325 as inputs to language generation model 310. Comparison prompt 325 incudes instructions to generate an embedding of each fact of a set of facts (e.g., fact embedding 330 for fact 315) and embeddings of each of the set of structural element descriptions (e.g., description embeddings 335 for set of structural element descriptions 320), to calculate a similarity score (e.g., a cosine similarity) between the fact embedding and each of the description embeddings (e.g., similarity scores 340), and to generate attribution information for the fact (e.g., attribution information 345) by identifying one or more structural elements of the data store corresponding to the top k similarity scores (e.g., the highest cosine similarities). In an example, for each fact fᵢ, language generation model 310 is instructed to select each structural element corresponding to a similarity score between the fact embedding e(fᵢ) and the description embeddings e(d)∀D higher than a threshold n.

Language generation model 310 generates the attribution information based on the comparison prompt, the fact, and the set of structural element descriptions. In some embodiments, the attribution information comprises an identification of a location of a structural element within the data store. In some embodiments, the attribution information includes an association of the identified structural element with the fact. In some embodiments, the attribution information identifies an element of the data store as a source for the input text. In some embodiments, data processing apparatus 305 displays the attribution information by displaying at least a portion of the data store corresponding to the element (for example, by highlighting a portion of a visual representation of the data store corresponding to the element).

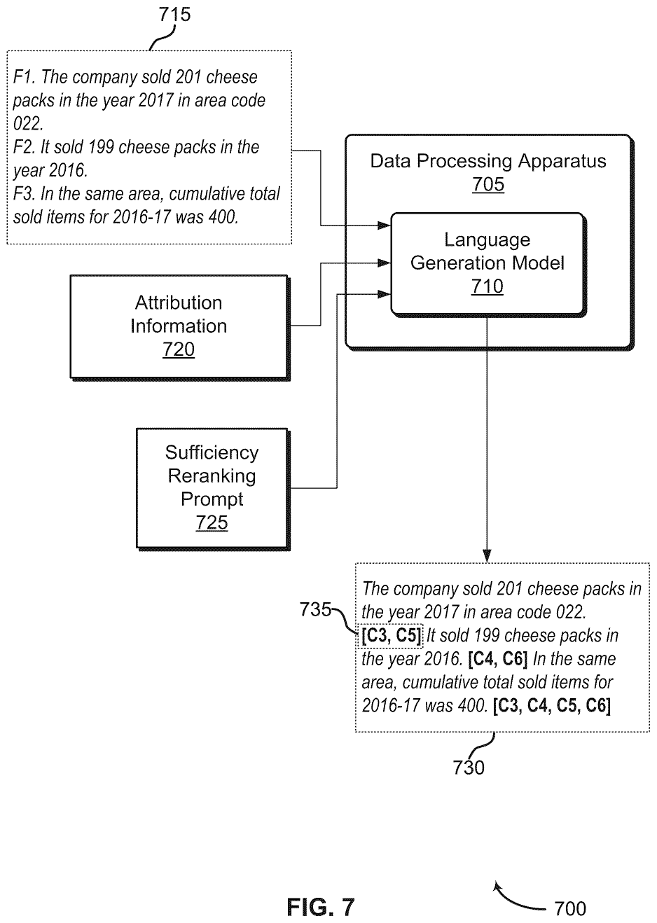

In some embodiments, language generation model 310 generates an augmented text based on the input text and the attribution information by inserting the attribution information next to a corresponding portion of the input text. In some embodiments, language generation model 310 generates an augmented text based on the input text, the attribution information, and a sufficiency reranking prompt as described with reference to FIG. 7.

Data processing system 300 is an example of, or includes aspects of, the corresponding element described with reference to FIGS. 1 and 4-7. Data processing apparatus 305 is an example of, or includes aspects of, the corresponding element described with reference to FIGS. 1, 4-7, and 12-13. Language generation model 310 is an example of, or includes aspects of, the corresponding element described with reference to FIGS. 1, 4-7, and 13.

Fact 315 is an example of, or includes aspects of, the corresponding element described with reference to FIGS. 6 and 7. Set of structural element descriptions 320 is an example of, or includes aspects of, the corresponding element described with reference to FIG. 5. Attribution information 345 is an example of, or includes aspects of, the corresponding elements described with reference to FIG. 7.

FIG. 4 shows an example of a data processing system 400 for formatting a data store 420 according to aspects of the present disclosure. The example shown includes data processing system 400, data store 420, labeled data store 425, formatting prompt 430, and data table 435. In one aspect, data processing system 400 includes data processing apparatus 405.

In one aspect, data processing apparatus 405 includes extraction model 410 and language generation model 415.

Referring to FIG. 4, according to some aspects, data processing apparatus 405 converts a data store (e.g., data store 420) into a tabular format to obtain a data table (e.g., data table 435). According to some aspects, language generation model 415 is more proficient in processing data presented in a tabular format such as HTML or XML than in other formats.

In an example implementation, extraction model 410 generates a labeled image rendering of the data store including separately labeled regions corresponding to each row and column to obtain a labeled data store (e.g., labeled data store 425). In some embodiments, extraction model 410 is also used to extract data store 420 from a document. The document may be obtained from a user or a database.

Then, data processing apparatus 405 provides formatting prompt 430 to language generation model 415 along with the labeled data store. Formatting prompt 430 includes instructions to convert the labeled data store into the tabular format. Formatting prompt 430 may include text describing the tabular format (e.g., format documentation). Formatting prompt 430 may include one or more examples of data that is converted into the tabular format. Language generation model 415 generates the data table based on formatting prompt 430 and the labeled data store. The labeled regions in the labeled data store increase an accuracy of language generation model 415 for generating the data table. In some embodiments, the data table maximizes a comprehension and processing capability of language generation model 415.

According to some aspects, extraction model 410 comprises extraction parameters (e.g., machine learning parameters) stored in a memory unit of data processing apparatus 405 (such as the memory unit 1310 described with reference to FIG. 13). In some embodiments, extraction model 410 comprises a vision transformer.

A vision transformer (ViT) is a type of deep learning model designed for image recognition tasks. Unlike a traditional convolutional neural networks, which process images using spatial hierarchies of convolutions, a ViT applies the transformer architecture, originally developed for natural language processing, to image data.

A ViT splits an image into small, fixed-size patches and then linearly embeds the patches into a sequence of feature vectors. Each feature vector is then assigned a positional encoding to retain spatial information. The sequences are fed into a standard transformer encoder, which processes the sequences using layers of self-attention and feedforward networks. The ViT thereby learns relationships between different parts of the image, regardless of spatial proximity, allowing the Vit to capture global dependencies.

Data processing system 400 is an example of, or includes aspects of, the corresponding element described with reference to FIGS. 1, 3, and 5-7. Data processing apparatus 405 is an example of, or includes aspects of, the corresponding element described with reference to FIGS. 1, 3, 5-7, and 12-13. Language generation model 415 is an example of, or includes aspects of, the corresponding element described with reference to FIGS. 1, 3, 5-7, and 13.

Data store 420 is an example of, or includes aspects of, the corresponding element described with reference to FIG. 1. Data table 435 is an example of, or includes aspects of, the corresponding element described with reference to FIG. 5.

FIG. 5 shows an example of a data processing system 500 for generating a set of structural element descriptions according to aspects of the present disclosure. The example shown includes data processing system 500, data table 515, descriptive prompt 520, and set of structural element descriptions 525. In one aspect, data processing system 500 includes data processing apparatus 505. In one aspect, data processing apparatus 505 includes language generation model 510.

Referring to FIG. 5, according to some aspects, language generation model 550 generates a set of structural element descriptions (e.g., set of structural element descriptions 525) based on a data table (e.g., data table 515) or a data store. Using the data table maximizes a comprehension and processing capability of language generation model 510 for generating the set of structural element descriptions.

Tabular data interpretation relies on accurately understanding semantics of cell-level information contextualized with structure metadata and underlying patterns across table rows and columns. Raw content of a table may contain ambiguous information (e.g., abbreviations, domain-specific terms, signs, numbers with or without units, ill-defined row/column headers) that requires further clarification and may not have sufficient context for automated factual attribution.

In some embodiments, the set of structural element descriptions is generated to disambiguate the data store or the data table. Data processing apparatus 505 provides descriptive prompt 520 to language generation model 510. Descriptive prompt 520 includes instructions to generate the set of structural element descriptions based on the data store or the data table. The descriptive prompt includes instructions to generate the set of structural element descriptions based on one or more of header metadata augmentation, trend analysis augmentation, and self-referential summary augmentation. The set of structural element descriptions act as proxy representations of the structural elements of the data store or the data table. In the example of FIG. 5, set of structural element descriptions 525 includes natural language descriptions of structural elements (e.g., rows and columns) of data table 515.

Header metadata augmentation includes generating text that describes each cell item (e.g., structural element) of the data store or the data table based on one or more levels of associated row and column header information, thereby promoting comprehensive data categorization. Table headers are useful for defining a meaning and context of row/column structured data, linking each cell item to specific hierarchical fields.

Trend analysis augmentation includes generating text that describes quantitative comparisons, numerical ranges, and/or statistical data trends across all rows and columns of the data store or the data table. Statistical trend analysis of numerical data helps summarize key quantitative characteristics and tendencies across the data store or the data table.

Self-referential summary augmentation includes generating text that provides a narrative description of each row and column of the data store or the data table to help contextualize categorical and numerical information in coherent natural language, thereby explaining interrelationships between the structural elements of the data store or the data table.

Data processing system 500 is an example of, or includes aspects of, the corresponding element described with reference to FIGS. 1, 3-4, and 6-7. Data processing apparatus 505 is an example of, or includes aspects of, the corresponding element described with reference to FIGS. 1, 3-4, 6-7, and 12-13. Language generation model 510 is an example of, or includes aspects of, the corresponding element described with reference to FIGS. 1, 3-4, 6-7, and 13. Data table 515 is an example of, or includes aspects of, the corresponding element described with reference to FIG. 4.

FIG. 6 shows an example of a data processing system 600 for decomposing input text according to aspects of the present disclosure. The example shown includes data processing system 600, input text 615, decomposition prompt 620, and set of facts 625. In one aspect, data processing system 600 includes data processing apparatus 605. In one aspect, data processing apparatus 605 includes language generation model 610.

Referring to FIG. 6, an answer text that is generated based on a data store may include multiple facts derived from various structural elements (e.g., table rows and columns) of a data store. It is helpful to distill attributable facts from an answer text such that each attributable fact can be mapped to specific structural elements of the data store, thereby enhancing interpretability and facilitating precise citations.

Accordingly, in some embodiments, data processing apparatus 605 provides decomposition prompt 620 and an input text (e.g., input text 615) to language generation model 610. In some embodiments, the input text comprises an answer generated by language generation model 610 based on a data store and a query relating to the data store. Decomposition prompt 620 includes an instruction to decompose the input text into a set of one or more facts (e.g., set of facts 625), where each fact may be separately attributable to one or more structural elements of a data store. Decomposition prompt 620 may include a set of examples of input text decomposition. According to some aspects, the set of facts comprises one or more labeled statements. For example, set of facts 625 includes three separately labeled statements, or facts. In some embodiments, language generation model 610 generates the set of facts based on the input text and decomposition prompt 620. Additionally or alternatively, in some embodiments, language generation model 610 generates the set of facts by generating an output labeling each sentence of the input text as a separate fact.

In some embodiments, data processing apparatus 605 uses a natural language inference model (e.g., a machine learning model including a transformer) that is trained to verify that each fact entails the input text (e.g., each fact must be true given the input text). The natural language inference model may include natural language inference parameters (e.g., machine learning parameters) stored in a memory unit of data processing apparatus 605 (such as the memory unit 1310 described with reference to FIG. 13). In some embodiments, data processing apparatus 605 rejects each fact that does not entail the input text. Therefore, in some embodiments, the set of facts includes facts that entail the input text.

Data processing system 600 is an example of, or includes aspects of, the corresponding element described with reference to FIGS. 1, 3-5, and 7. Data processing apparatus 605 is an example of, or includes aspects of, the corresponding element described with reference to FIGS. 1, 3-5, 7, and 12-13. Language generation model 610 is an example of, or includes aspects of, the corresponding element described with reference to FIGS. 1, 3-5, 7, and 13. Set of facts 625 is an example of, or includes aspects of, the corresponding element described with reference to FIG. 7.

FIG. 7 shows an example of a data processing system 700 for sufficiency re-reranking according to aspects of the present disclosure. The example shown includes data processing system 700, set of facts 715, attribution information 720, sufficiency reranking prompt 725, and augmented text 730. In one aspect, data processing system 700 includes data processing apparatus 705. In one aspect, data processing apparatus 705 includes language generation model 710. In one aspect, augmented text 730 includes reranked attribution information 735.

Referring to FIG. 7, according to some aspects, to further increase an accuracy of the attribution information generated as described with reference to FIG. 3, language generation model 710 generates an augmented text (e.g., augmented text 730) including an input text along with a minimal set of attribution information (including, e.g., attribution information 735) to sufficiently explain each factual claim in the input text (e.g., a set of facts, such as set of facts 715). In an example, data processing apparatus 705 provides the set of facts, the attribution information, and sufficiency reranking prompt 725 as inputs to language generation model 710.

Sufficiency reranking prompt 725 includes instructions to remove attribution information that is not necessary for supporting a fact in the set of facts. Sufficiency reranking prompt 725 may include instructions to re-rank and retrieve relevant attribution information. Sufficiency reranking prompt 725 may include an instruction to generate a “chain-of-thought” explanation that reasons about the relevant attribution information in a multi-hop fashion. Language generation model 710 generates the augmented text based on the set of facts, the attribution information, and sufficiency reranking prompt 725. In an example, augmented text 730 includes reranked attribution information 735 which identifies columns 3 and 5 (C3 and C5) of a data store as support for a fact “The company sold 201 cheese packs in the year 2017 in area code 022” in input text corresponding to the set of facts and the data store.

Data processing system 700 is an example of, or includes aspects of, the corresponding element described with reference to FIGS. 1 and 3-6. Data processing apparatus 705 is an example of, or includes aspects of, the corresponding element described with reference to FIGS. 1, 3-6, and 12-13. Language generation model 710 is an example of, or includes aspects of, the corresponding element described with reference to FIGS. 1, 3-6, and 13. Set of facts 715 is an example of, or includes aspects of, the corresponding element described with reference to FIG. 6.

FIG. 8 shows an example of a transformer 800 according to aspects of the present disclosure. The example shown includes encoder 805, decoder 820, input 840, input embedding 845, input positional encoding 850, previous output 855, previous output embedding 860, previous output positional encoding 865, and output 870. According to some aspects, transformer 800 comprises architectural elements of the language generation model 1315 described with reference to FIG. 13.

According to some aspects, a transformer comprises one or more ANNs comprising attention mechanisms that enable the transformer to weigh an importance of different words or tokens within a sequence. In some examples, a transformer processes entire sequences simultaneously in parallel using multiple attention heads, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Encoder 805 includes multi-head self-attention sublayer 810 and feed-forward network sublayer 815. Decoder 820 includes first multi-head self-attention sublayer 825, second multi-head self-attention sublayer 830, and feed-forward network sublayer 835.

Encoder 805 is configured to map input 840 to a sequence of continuous representations that are fed into decoder 820. Decoder 820 generates output 870 (e.g., a prediction of an output sequence of words or tokens) based on the output of encoder 805 and previous output 855 (e.g., a previously predicted output sequence), which allows for the use of autoregression.

For example, encoder 805 parses input 840 into tokens and vectorizes the parsed tokens to obtain input embedding 845, and adds input positional encoding 850 (e.g., positional encoding vectors for input 840 of a same dimension as input embedding 845) to input embedding 845. Input positional encoding 850 includes information about relative positions of words or tokens in input 840.

Encoder 805 comprises one or more encoding layers that generate contextualized token representations, where each representation corresponds to a token that combines information from other input tokens via self-attention mechanism. Each encoding layer of encoder 805 comprises a multi-head self-attention sublayer (e.g., multi-head self-attention sublayer 810). The multi-head self-attention sublayer implements a multi-head self-attention mechanism that receives different linearly projected versions of queries, keys, and values to produce outputs in parallel at each attention head of transformer 800. Each encoding layer of encoder 805 also includes a fully connected feed-forward network sublayer (e.g., feed-forward network sublayer 815) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

Each layer employs different weight parameters (W1, W2) and different bias parameters (b1, b2) to apply a same linear transformation to each word or token in input 840.

Each sublayer of encoder 805 is followed by a normalization layer that normalizes a sum computed between a sublayer input x and an output sublayer (x) generated by the sublayer:

$$layernorm ( x + sublayer ( x ) ) \qquad ( 2 )$$

Encoder 805 is bidirectional because encoder 805 attends to each word or token in input 840 regardless of a position of the word or token in input 840. Decoder 820 comprises one or more decoding layers (e.g., six decoding layers). Each decoding layer comprises three sublayers including a first multi-head self-attention sublayer (e.g., first multi-head self-attention sublayer 825), a second multi-head self-attention sublayer (e.g., second multi-head self-attention sublayer 830), and a feed-forward network sublayer (e.g., feed-forward network sublayer 835). Each sublayer of decoder 820 is followed by a normalization layer that normalizes a sum computed between a sublayer input x and an output sublayer (x) generated by the sublayer. Decoder 820 generates previous output embedding 860 of previous output 855 and adds previous output positional encoding 865 (e.g., position information for words or tokens in previous output 855) to previous output embedding 860. Each first multi-head self-attention sublayer receives the combination of previous output embedding 860 and previous output positional encoding 865 and applies a multi-head self-attention mechanism to the combination. For each word in an input sequence, each first multi-head self-attention sublayer of decoder 820 attends only to words preceding the word in the sequence, and so a prediction of transformer 800 for a word at a particular position only depends on known outputs for a word that came before the word in the sequence. In some cases, each first multi-head self-attention sublayer implements multiple single-attention functions in parallel by introducing a mask over values produced by the scaled multiplication of matrices Q and K by suppressing matrix values that would otherwise correspond to disallowed connections.

Each second multi-head self-attention sublayer implements a multi-head self-attention mechanism similar to the multi-head self-attention mechanism implemented in each multi-head self-attention sublayer of encoder 805 by receiving a query Q from a previous sublayer of decoder 820 and a key K and a value V from the output of encoder 805, allowing decoder 820 to attend to each word in the input 840. Each feed-forward network sublayer implements a fully connected feed-forward network similar to feed-forward network sublayer 815. The feed-forward network sublayers are followed by a linear transformation and a softmax to generate a prediction of output 870.

### Generating Attribution Information

FIG. 9 shows an example of a method 900 for generating attribution information according to aspects of the present disclosure. Referring to FIG. 9, a data processing system (such as the data processing system 100 described with reference to FIG. 1) generates attribution information from a data store for an input text based on a natural language description of the data store using a language generation model. Generating the attribution information based on the natural language description of the data store using a language generation model is more accurate than generating the attribution information based on the raw data store and the input text using a comparative language model, and is more accurate than retrieving the attribution information based on embeddings of the raw data store and of the input text.

At operation 905, the system obtains a data store and input text, where the data store includes data and the input text describes the data. In some cases, the operations of this step refer to, or may be performed by, a data processing apparatus as described with reference to FIGS. 1, 3-7, and 12-13. In some embodiments, a user provides one or more of the data store and the input text to the data processing apparatus. In some embodiments, the data processing apparatus retrieves one or more of the data store and the input text from a database (such as the database 125 described with reference to FIG. 1). In some embodiments, the data processing apparatus generates the input text based on the data store using a language generation model (e.g., the language generation model 115 described with reference to FIG. 1).

In some embodiments, the data processing apparatus extracts the data store from a document using an extraction model as described with reference to FIG. 4. In some embodiments, the data processing apparatus converts the data store to a table format as described with reference to FIG. 4.

At operation 910, the system generates a description of a structural element of the data. In some cases, the operations of this step refer to, or may be performed by, a language generation model as described with reference to FIGS. 1, 3-7, and 13. According to some aspects, the language generation model generates the description of the structural element as described with reference to FIG. 5.

At operation 915, the system generates attribution information for the input text based on the description of the structural element. In some cases, the operations of this step refer to, or may be performed by, a language generation model as described with reference to FIGS. 1, 3-7, and 13. According to some aspects, the language generation model generates the attribution information as described with reference to FIG. 3. In some embodiments, the language generation model generates an augmented text based on the input text and the attribution information as described with reference to FIG. 7.

FIG. 10 shows an example of a method 1000 for generating attribution information for a data table according to aspects of the present disclosure. Referring to FIG. 10, a data processing system (such as the data processing system 100 described with reference to FIG. 1) generates attribution information from a data table for an input text based on a natural language description of the data store using a language generation model. Generating the attribution information based on the natural language description of the data table using a language generation model is more accurate than generating the attribution information based on the raw data store and the input text using a comparative language model, and is more accurate than retrieving the attribution information based on embeddings of the raw data store and of the input text.

At operation 1005, the system obtains a data store and input text, where the data store includes data and the input text describes the data. In some cases, the operations of this step refer to, or may be performed by, a data processing apparatus as described with reference to FIGS. 1, 3-7, and 12-13. In some embodiments, a user provides one or more of the data store and the input text to the data processing apparatus. In some embodiments, the data processing apparatus retrieves one or more of the data store and the input text from a database (such as the database 125 described with reference to FIG. 1). In some embodiments, the data processing apparatus generates the input text based on the data store using a language generation model (e.g., the language generation model 115 described with reference to FIG. 1).

At operation 1010, the system converts the data store based on a table format to obtain a data table. In some cases, the operations of this step refer to, or may be performed by, a language generation model as described with reference to FIGS. 1, 3-7, and 13. According to some aspects, the language generation model obtains the data table as described with reference to FIG. 4.

At operation 1015, the system generates a description of the data table. In some cases, the operations of this step refer to, or may be performed by, a language generation model as described with reference to FIGS. 1, 3-7, and 13. According to some aspects, the language generation model generates the description of the data table as described with reference to FIG. 5.

At operation 1020, the system generates attribution information for the input text based on the description of the data table. In some cases, the operations of this step refer to, or may be performed by, a language generation model as described with reference to FIGS. 1, 3-7, and 13. According to some aspects, the language generation model generates the attribution information as described with reference to FIG. 3.

Accordingly, a method for data processing is described. One or more aspects of the method include obtaining a data store and input text, wherein the data store includes data and the input text describes the data; generating, using a language generation model, a description of a structural element of the data; and generating, using the language generation model, attribution information for the input text based on the description of the structural element.

In some examples, generating the attribution information includes identifying an element of the data store as a source for the input text. Some examples of the method further include displaying at least a portion of the data store corresponding to the element. Some examples of the method further include generating an augmented text based on the input text and the attribution information.

Some examples of the method further include converting the data store to a table format, wherein the structural element corresponds to the table format. Some examples of the method further include computing a similarity score between the structural element and at least a portion of the input text, wherein the attribution information is based on the similarity score. Some examples of the method further include decomposing the input text to obtain a plurality of text elements, wherein the attribution information links at least one of the text elements to the structural element.

Some examples of the method further include ranking the structural element based on relevance to the input text. Some examples of the method further include generating statistical information about the structural element based on the data, wherein the description of the structural element is generated based on the statistical information. In some aspects, the structural element comprises a table row or a table column of the data store.

Furthermore, a method for data processing is described. One or more aspects of the method include obtaining a data store and input text, wherein the data store includes data and the input text describes the data; converting the data store based on a table format to obtain a data table; generating, using a language generation model, a description of the data table; and generating, using the language generation model, attribution information for the input text based on the description of the data table.

In some examples, generating the attribution information includes identifying an element of the data store as a source for the input text. Some examples of the method further include computing a similarity score between the element of the data store and at least a portion of the input text, wherein the attribution information is based on the similarity score. Some examples of the method further include decomposing the input text to obtain a plurality of text elements, wherein the attribution information links at least one of the text elements to the element of the data store.

Some examples of the method further include displaying at least a portion of the data store corresponding to the element. Some examples of the method further include generating an augmented text based on the input text and the attribution information. Some examples of the method further include generating statistical information about the data store based on the data, wherein the description of the data table is generated based on the statistical information.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 11 shows an example of a flow diagram depicting an algorithm as a step-by-step procedure 1100 for training a machine learning model according to aspects of the present disclosure. In some embodiments, the procedure 1100 describes an operation of the training component 1325 described for configuring the language generation model 1315 as described with reference to FIG. 13. The procedure 1100 provides one or more examples of generating training data, use of the training data to train a machine learning model, and use of the trained machine learning model to perform a task.

To begin in this example, a machine learning system collects training data (block 1102) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1104) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1106). Initialization of the machine learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine learning model (i.e., predictions) and target values (e.g., as expressed by the training data) to be used to train the machine learning model. Additionally, an optimization algorithm is selected (1112) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1118) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1120), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine learning model using the training data (block 1118) in this example.

If the stopping criterion is met (“yes” from decision block 1120), the trained machine learning model is then utilized to generate an output based on subsequent data (block 1122). The trained machine learning model, for instance, is trained to perform a task as described above and therefore once trained is configured to perform that task based on subsequent data received as an input and processed by the machine learning model.

An accuracy of the data processing system according to aspects of the present disclosure in generating attribution information is compared against a baseline few-shot in-context learning large language model (LLM) approach and a baseline post-hoc retrieval approach. The baseline few-shot in-context LLM approach includes prompting an LLM with few-shot examples to generate an answer including in-line citations based on an input text and a data store. The baseline post-hoc retrieval approach includes using a dense retriever to retrieve top-k structural elements of a data store for an input text. The data processing system achieves a better F1 score (determined based on a precision and recall) than the baseline few-shot in-context learning large language model (LLM) approach and the baseline post-hoc retrieval approach in generating attribution information for an input text based on a data store.

### Data Processing Apparatus

FIG. 12 shows an example of a computing device according to aspects of the present disclosure. Computing device 1200 is an example of, or includes aspects of, the data processing apparatus described with reference to FIGS. 1, 3-7, and 13. In one aspect, computing device 1200 includes processor(s) 1205, memory subsystem 1210, communication interface 1215, I/O interface 1220, user interface component(s) 1225, and channel 1230. In some embodiments, computing device 1200 includes one or more processors 1205 that can execute instructions stored in memory subsystem 1210.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI.

FIG. 13 shows an example of a data processing apparatus 1300 according to aspects of the present disclosure. Data processing apparatus 1300 is an example of, or includes aspects of, the corresponding element described with reference to FIGS. 1, 3-7, and 12. In some embodiments, data processing apparatus 1300 includes processor unit 1305, memory unit 1310, language generation model 1315, I/O module 1320, and training component 1325. Training component 1325 updates parameters of the language generation model 1315 stored in memory unit 1310. In some examples, the training component 1325 is located outside the data processing apparatus 1300.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1310 to perform various functions. In some aspects, processor unit 1305 includes special purpose components for modem processing, baseband processing, digital signal processing, or transmission processing. According to some aspects, processor unit 1305 comprises one or more processors 1205 described with reference to FIG. 12.

Memory unit 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1310 includes a basic input/output system (BIOS) that controls basic hardware or software operations, such as an interaction with peripheral components or devices. In some cases, memory unit 1310 includes a memory controller that operates memory cells of memory unit 1310. For example, the memory controller may include a row decoder, column decoder, or both. In some cases, memory cells within memory unit 1310 store information in the form of a logical state. According to some aspects, memory unit 1310 is an example of the memory subsystem 1210 described with reference to FIG. 12.

According to some aspects, data processing apparatus 1300 uses one or more processors of processor unit 1305 to execute instructions stored in memory unit 1310 to perform functions described herein. For example, the data processing apparatus 1300 may perform operations comprising obtaining a data store and input text, wherein the data store includes data and the input text describes the data; generating, using a language generation model, a description of a structural element of the data; and generating, using the language generation model, attribution information for the input text based on the description of the structural element.

The memory unit 1310 may include a language generation model 1315. According to some aspects, language generation model 1315 comprises machine learning parameters stored in memory unit 1310. Language generation model 1315 is an example of, or includes aspects of, the corresponding element described with reference to FIGS. 1 and 3-7.

In some embodiments, language generation model 1315 is an artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of language generation model 1315 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1325 may train language generation model 1315. For example, parameters of language generation model 1315 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 11). The goal of the training process may be to find optimal values for the parameters that allow the language generation model 1315 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the language generation model 1315 can be used to make predictions on new, unseen data (i.e., during inference).

I/O module 1320 receives inputs from and transmits outputs of the data processing apparatus 1300 to other devices or users. For example, I/O module 1320 receives inputs for the language generation model 1315 and transmits outputs of the language generation model 1315.

According to some aspects, I/O module 1320 is an example of the I/O interface 1220 described with reference to FIG. 12.

According to some aspects, training component 1325 comprises executable code (e.g., software) stored in memory unit 1310, firmware, one or more hardware circuits, or a combination thereof.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media.

For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data processing, comprising:
obtaining a data store and input text, wherein the data store includes data and the input text describes the data;
generating, using a language generation model, a description of a structural element of the data; and
generating, using the language generation model, attribution information for the input text based on the description of the structural element.

2. The method of claim 1, wherein generating the attribution information comprises:
identifying an element of the data store as a source for the input text.

3. The method of claim 2, further comprising:
displaying at least a portion of the data store corresponding to the element.

4. The method of claim 1, further comprising:
generating an augmented text based on the input text and the attribution information.

5. The method of claim 1, further comprising:
converting the data store to a table format, wherein the structural element corresponds to the table format.

6. The method of claim 1, further comprising:
computing a similarity score between the structural element and at least a portion of the input text, wherein the attribution information is based on the similarity score.

7. The method of claim 1, further comprising:
decomposing the input text to obtain a plurality of text elements, wherein the attribution information links at least one of the text elements to the structural element.

8. The method of claim 1, further comprising:
ranking the structural element based on relevance to the input text.

9. The method of claim 1, further comprising:
generating statistical information about the structural element based on the data, wherein the description of the structural element is generated based on the statistical information.

10. The method of claim 1, wherein:
the structural element comprises a table row or a table column of the data store.

11. A non-transitory computer readable medium storing code for data processing, the code comprising instructions that, when executed by at least one processor, cause the at least one processor to perform operations comprising:
obtaining a data store and input text, wherein the data store includes data and the input text describes the data;
converting the data store based on a table format to obtain a data table;
generating, using a language generation model, a description of the data table; and
generating, using the language generation model, attribution information for the input text based on the description of the data table.

12. The non-transitory computer readable medium of claim 11, wherein generating the attribution information comprises:
identifying an element of the data store as a source for the input text.

13. The non-transitory computer readable medium of claim 12, the code further comprising instructions that, when executed by the at least one processor, cause the at least one processor to perform operations comprising:
computing a similarity score between the element of the data store and at least a portion of the input text, wherein the attribution information is based on the similarity score.

14. The non-transitory computer readable medium of claim 12, the code further comprising instructions that, when executed by the at least one processor, cause the at least one processor to perform operations comprising:
decomposing the input text to obtain a plurality of text elements, wherein the attribution information links at least one of the text elements to the element of the data store.

15. The non-transitory computer readable medium of claim 12, the code further comprising instructions that, when executed by the at least one processor, cause the at least one processor to perform operations comprising:
displaying at least a portion of the data store corresponding to the element.

16. The non-transitory computer readable medium of claim 11, the code further comprising instructions that, when executed by the at least one processor, cause the at least one processor to perform operations comprising:
generating an augmented text based on the input text and the attribution information.

17. The non-transitory computer readable medium of claim 11, the code further comprising instructions that, when executed by the at least one processor, cause the at least one processor to perform operations comprising:
generating statistical information about the data store based on the data, wherein the description of the data table is generated based on the statistical information.

18. A system comprising:
a memory component; and
a processing device coupled to the memory component, the processing device configured to perform operations comprising:
obtaining a data store and input text, wherein the data store includes data and the input text describes the data;
generating, using a language generation model, a description of a structural element of the data; and
generating, using the language generation model, attribution information for the input text based on the description of the structural element.

19. The system of claim 18, the processing device being further configured to perform:
identifying an element of the data store as a source for the input text.

20. The system of claim 18, the processing device being further configured to perform:
computing a similarity score between the structural element and at least a portion of the input text, wherein the attribution information is based on the similarity score.
